(19) United States
(12) Patent Application Publication
(10) Pub. No.: US 2026/0108991 A1
(43) Pub. Date: Apr. 23, 2026

(54) MECHANICAL DEVICE WITH A LEVELING DEVICE FOR ALIGNING A COMBINED PRODUCT OF A WORKPIECE PART AND A SCRAP SKELETON FROM CUTTING PROCESSING OF A WORKPIECE BEFORE SEPARATION OF THE WORKPIECE PART

(71) Applicant: TRUMPF Werkzeugmaschinen SE + Co. KG, Ditzingen (DE)

(72) Inventors: Patrick Mach, Korb (DE); Stefan Krause, Wilthen (DE); Ralf Mueller, Dohma (DE); Falk Waurisch, Schmölln-Putzkau (DE)

(21) Appl. No.: 19/363,682

(22) Filed: Oct. 21, 2025

(30) Foreign Application Priority Data
Oct. 21, 2024 (DE) 102024130463.4

(51) Int. Cl. B23K 37/04; B23K 26/38

(52) U.S. Cl. CPC B23K 37/04; B23K 26/38

(57) ABSTRACT

A mechanical device for separating a workpiece part, including a holder, a separator, and a product deposition area. The holder is configured to immobilize, in a direction of gravity, a combined product before separation of the workpiece part and to immobilize, in the direction of gravity, a scrap skeleton after separation of the workpiece part. The separator is configured to detach the workpiece part from the combined product. The product deposition area is arranged at a vertical distance below the combined product. The product deposition area for supporting the workpiece part detached from the combined product has a horizontal deposition surface which extends along the combined product. A leveler is provided, by which, before the workpiece part is detached from the combined product, the combined product is configured to be aligned with a main plane of the combined product parallel to the horizontal deposition surface.

### CROSS REFERENCE TO RELATED APPLICATIONS

This application claims benefit to German Patent Application No. DE 10 2024 130 463.4, filed on Oct. 21, 2024, which is hereby incorporated by reference herein.

### FIELD

The invention relates to a mechanical device for separating a workpiece part provided as a processing product from cutting processing.

### BACKGROUND

In sheet metal cutting processing by way of a cutting device, for example a laser cutting device, the processing products are sheet metal parts and a scrap skeleton that at least partly surrounds the sheet metal parts. To simplify removal of the processing products from the cutting device, the sheet metal parts are not completely cut away from the scrap skeleton during sheet metal cutting processing. Instead, microjoints or nanojoints are left between the scrap skeleton and the sheet metal parts, which allow the scrap skeleton and the sheet metal parts to be handled as a unit during unloading of the cutting device. It is also conceivable for sheet metal parts produced during sheet metal cutting processing to be held in the scrap skeleton due to thermal stresses arising or as a result of tilting after the cutting process. Separation of the sheet metal parts from the scrap skeleton takes place in a method step following the sheet metal cutting processing.

The prior art in this area is disclosed in JP 2000094057 A. The prior art relates to a mechanical assembly and to a method for sheet metal punching processing. At a punching station of the mechanical assembly, sheet metal parts and a scrap skeleton are produced from a sheet metal panel, the sheet metal parts being connected to the scrap skeleton via microjoints after completion of the sheet metal punching processing. The combined product consisting of the scrap skeleton and the sheet metal parts connected thereto is moved to a separating station, where a plurality of roller pairs succeed one another in a direction of movement of the scrap skeleton and the sheet metal parts and are offset alternately upward and downward relative to one another and perpendicular to the direction of movement of the scrap skeleton and the sheet metal parts. A gap is formed between the rollers of each roller pair. Traveling from the punching station, the scrap skeleton with the sheet metal parts passes through the gap past multiple roller pairs succeeding one another in the direction of movement. Due to the mutual offset of the roller pairs, the scrap skeleton with the sheet metal parts is bent multiple times as it passes through the roller pairs. At the same time, the scrap skeleton with the sheet metal parts is caused to vibrate perpendicularly to the direction of movement. As a result, the microjoints remaining between the scrap skeleton and the sheet metal parts during sheet metal punching processing break, and the sheet metal parts detached from the scrap skeleton fall onto a product deposition table arranged below the roller pairs of the separating station.

### SUMMARY

In an embodiment, the present disclosure provides a mechanical device for separating a workpiece part provided as a processing product from cutting processing of a plate-type workpiece, comprising a metal sheet, from a scrap skeleton provided as a further processing product from cutting processing of a workpiece under the effect of gravity from a combined product including the scrap skeleton and the workpiece part, the mechanical device comprising a holder, a separator, and a product deposition area. The holder is configured to immobilize, effective in a direction of gravity, the combined product before separation of the workpiece part and to immobilize, effective in the direction of gravity, the scrap skeleton after separation of the workpiece part. The separator is configured to detach the workpiece part from the combined product immobilized by the holder. The product deposition area is arranged at a vertical distance below the combined product immobilized by the holder. The product deposition area for supporting the workpiece part detached from the combined product under the effect of gravity has a horizontal deposition surface which extends along the combined product immobilized by the holder. A leveler is provided, by which, before the workpiece part is detached from the combined product immobilized by the holder, the combined product immobilized by the holder is configured to be aligned with a main plane of the combined product parallel to the horizontal deposition surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a mechanical device for separating sheet metal parts from a scrap skeleton from sheet metal cutting processing with a horizontally aligned first combined product of the sheet metal parts and the scrap skeleton;

FIG. 2 illustrates the mechanical device according to FIG. 1 with a second combined product of sheet metal parts and a scrap skeleton inclined relative to the horizontal; and

FIG. 3 illustrates the arrangement according to FIG. 2 with the horizontally aligned second combined product.

### DETAILED DESCRIPTION

In an embodiment, the present disclosure provides a mechanical device for separating workpiece parts from a scrap skeleton from cutting processing of a workpiece, in which workpiece parts separated from the scrap skeleton are deposited in an orderly and gentle manner on a product deposition area of the mechanical device under the effect of gravity.

The leveling device provided in the present disclosure ensures that the combined product and thus also the workpiece part to be detached from the combined product is aligned horizontally and consequently parallel to the deposition surface of the product deposition area provided for deposition of the workpiece part when the workpiece part is detached from the combined product. In particular, if the workpiece part falls from a small height, the workpiece part, after being detached from the combined product, at least substantially maintains an alignment parallel to the deposition surface until it is deposited on the product deposition area. When it hits the deposition surface of the product deposition area, the workpiece part is at most slightly inclined toward the deposition surface of the product deposition area. Orderly and careful deposition of the workpiece part on the deposition surface of the product deposition area is thus ensured. Orderly deposition and the associated defined positioning of the workpiece parts on the product deposition area is particularly advantageous in cases where the product deposition area is unloaded automatically, for example by way of a robot. Careful handling of the workpiece part when depositing it on the deposition surface of the product deposition surface is particularly recommended in the case of workpiece parts that are susceptible to damage, for example due to their material or geometry.

According to an embodiment, the leveling device has a testing device and an adjusting device. Before the workpiece part is separated from the scrap skeleton, the testing device is used to check whether the combined product immobilized by the holding device with the workpiece part to be separated from the combined product is aligned horizontally and thus parallel to the deposition surface of the product deposition area. If this is not the case, the alignment of the combined product immobilized by way of the holding device is corrected by way of the adjusting device according to the present disclosure.

The testing device according to the present disclosure can comprise a measuring unit by way of which the vertical distance of the combined product from the horizontal reference plane is determined at at least three points of the combined product. If a non-horizontal alignment of the combined product is detected, a controlled actuator of the adjusting device can correct the misalignment of the combined product.

In an embodiment of the present disclosure, the alignment of the holding device provided for immobilizing the combined product relative to the horizontal reference plane reflects the alignment of the combined product relative to the horizontal reference plane. Accordingly, the testing device of the leveling device according to the present disclosure is configured to determine the alignment of the holding device relative to the horizontal reference plane. If the testing device detects that the actual alignment of the holding device deviates from the horizontal target alignment, the adjusting device of the leveling device according to the present disclosure modifies the alignment of the holding device.

In an embodiment, a support structure is provided for the holding device serving to immobilize the combined product, on which support structure the holding device is mounted in the vertical direction via at least one spacer arranged in the vertical direction between the support structure and the holding device. The spacer forms part of the adjusting device of the leveling device according to the present disclosure. The vertical dimension of the spacer can be changed by way of an actuator of the adjusting device. The actuator is used in cases in which a non-horizontal alignment of the holding device and thus also a non-horizontal alignment of the combined product immobilized by way of the holding device is detected by way of the testing device according to the present disclosure. In such cases, the vertical dimension of the spacer arranged between the support structure and the holding device is adjusted by way of the actuator of the adjusting device such that the holding device and the combined product immobilized thereto are aligned horizontally. By appropriately adjusting the vertical dimension of the spacer(s) arranged between the support structure and the holding device, the vertical distance of the combined product immobilized on the holding device from the product deposition area and thus the drop height of the workpiece part separated from the scrap skeleton can also be adjusted.

In an embodiment, the adjusting device of the leveling device according to the present disclosure comprises, in a further development, a plurality of spacers provided in the vertical direction between the support structure and the holding device, which spacers are offset from one another parallel to the main plane of the combined product immobilized by way of the holding device and the vertical dimension of which can be adjusted. In the event that the alignment of the holding device determined by way of the testing device of the leveling device according to the present disclosure deviates from the alignment of the horizontal reference plane, it is made possible to adjust the vertical dimensions of the spacers between the support structure and the holding device by way of the actuator of the adjusting device in such a way that the holding device extends parallel to the horizontal reference plane.

In an embodiment, the support structure is used as a reference system for testing and, if necessary, for adjusting a horizontal alignment of the combined product immobilized by way of the holding device.

In an embodiment, at least one pneumatic bellows with adjustable internal pressure and with at least one spring element with adjustable spring hardness is provided. In an embodiment, the spacer(s) are provided with an adjustable vertical dimension arranged between the support structure and the holding device.

In an embodiment of the mechanical device according to the present disclosure, the separating unit of the mechanical device has a vibration generator which is configured to generate vertical vibrations of the holding device immobilizing the combined product, which vibrations cause the workpiece part to be detached from the combined product. A spring-damper device arranged between the holding device and the support structure and provided for vibration isolation of the holding device from the support structure simultaneously forms a spacer of the type mentioned above, the vertical dimension of which can be adjusted accordingly, if necessary, for the horizontal target alignment of the combined product immobilized by way of the holding device.

In an embodiment, the pneumatic bellows according to an above-described embodiment are provided and the spring element(s) according to an above-described embodiment are provided as spring-damper devices with such a dual function.

An embodiment provides the mechanical device according to the present disclosure, in which holding members are provided for immobilizing the combined product to the holding device and are adjustable on a base structure of the holding device parallel to the main plane of the combined product immobilized on the holding device relative to the base structure. By adjusting the holding members accordingly, the holding device can be adapted in particular to changing formats of the combined product to be immobilized on the holding device. As a result of repositioning the holding members and a related change in the position of the combined product on the holding device, the main plane of the combined product immobilized on the holding device can be deflected from a horizontal alignment during a previous positioning of the holding members. By a corresponding change in the vertical dimension of the spacer(s) arranged between the holding device and the support structure by way of the actuator of the adjusting device according to the present disclosure, the inclination of the main plane of the combined product immobilized by way of the repositioned holding members can be corrected in this case.

Preferably, the spacer(s) of the adjusting device are provided between the support structure and the base structure of the holding device.

When using a separating unit with vibration generator, the holding device is preferably excited at its base structure to execute vertical vibrations, which cause the workpiece part to be detached from the combined product.

Embodiments of the present disclosure will be explained in more detail below on the basis of exemplary schematic illustrations.

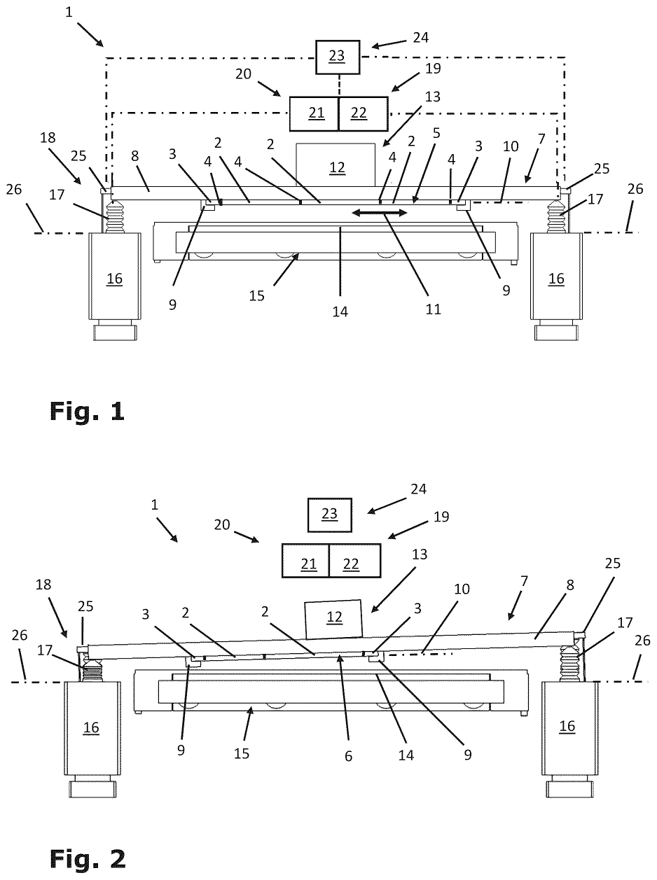

FIGS. 1 to 3 show a mechanical device 1 for separating workpiece parts in the form of sheet metal parts 2 from a scrap skeleton 3. The sheet metal parts 2 and the scrap skeleton 3 are processing products from sheet metal cutting processing by way of a laser cutting machine arranged away from the mechanical device 1.

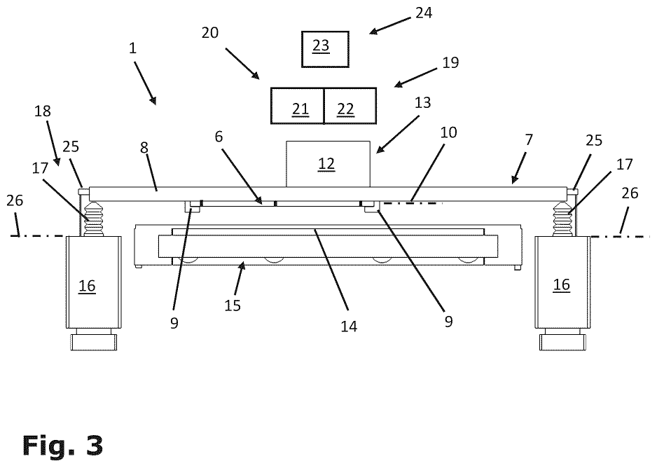

During cutting processing by way of the laser cutting machine, microjoints 4 were left between the sheet metal parts 2 and the scrap skeleton 3 as well as between mutually adjacent sheet metal parts 2. Due to the nanojoints 4, the sheet metal parts 2 and the scrap skeleton 3 form a combined product 5 in FIG. 1 and a combined product 6 in FIGS. 2 and 3. Both the combined product 5 and the combined product 6 were removed as a unit from the laser cutting machine and transferred to the mechanical device 1.

For the combined product 5 and the combined product 6, the mechanical arrangement 1 has a holding device 7 with a rigid base plate 8 as a base structure and with holding members in the form of grippers 9.

The combined product 5 and the combined product 6 are effectively immobilized on the holding device 7 in the direction of gravity by the grippers 9. The grippers 9 are attached to the base plate 8 and are arranged opposite one another at a mutual distance parallel to a main plane 10, indicated by dash-dotted lines, of the combined product 5, 6 immobilized on the holding device 7. In order to adapt to the different formats of the combined product 5, 6, the grippers 9 can be advanced parallel to the main plane 10 of the combined product 5, 6 immobilized on the holding device 7 relative to each other and relative to the base plate 8 in the direction of a double-headed arrow 11.

On the upper side of the base plate 8 of the holding device 7, there is attached a vibration generator 12, in the example shown an unbalanced mass exciter, which together with the holding device 7 forms a separating unit 13 of the mechanical arrangement 1. The holding device 7 with the combined product 5, 6 is caused to vibrate vertically by the vibration generator 12. As a result of vibration of the combined product 5, 6, the microjoints 4 remaining between the individual parts of the combined product 5, 6 break, and the sheet metal parts 2 are detached from the combined product 5, 6 immobilized by way of the holding device 7. The sheet metal parts 2 detached from the combined product 5, 6 fall under the effect of gravity onto a horizontal product deposition surface 14 of a product deposition area arranged below the holding device 7. In FIGS. 1 to 3, a pallet truck 15 of conventional construction is provided as the product deposition area.

The mechanical device 1 has a support structure 16 for mounting the holding device 7.

In the vertical direction between the support structure 16 and the holding device 7, spacers are arranged, which in the example shown are configured as pneumatic bellows 17 and by way of which the holding device 7 is effectively mounted on the support structure 16 in the vertical direction. The pneumatic bellows 17 are offset from one another parallel to the main plane 10 of the combined product 5, 6 immobilized by way of the holding device 7.

The pneumatic bellows 17 are spring-elastic in the vertical direction and, on the one hand, function as spring-damper devices for vibration isolation of the support structure 16 relative to the holding device 7 during the vertical vibration of the holding device 7 generated by the vibration generator 12 for detaching the sheet metal parts 2 from the combined product 5, 6. The pneumatic bellows 17 largely prevent the transmission of vertical vibrations from the holding device 7 to the support structure 16. Vibration isolation of the support structure 16 is of major importance inasmuch as the support structure 16, as a component of a higher-level automation unit of the laser cutting machine, is connected to further components of the automation unit.

In addition, the pneumatic bellows 17 are components of a leveling device 18 of the mechanical device 1, specifically of an adjusting device 19 of the leveling device 18.

In addition to the pneumatic bellows 17, the actuator 19 of the leveling device 18 comprises an actuator 20 connected to the pneumatic bellows 17. The actuator 20 for the pneumatic bellows 17 has a compressor 22 provided with a pressure regulator 21. By applying an appropriate air pressure to the pneumatic bellows 17, the vertical dimensions of the pneumatic bellows 17 can be adjusted independently of each other.

The actuator 20 of the adjusting device 19 is controlled by an evaluation unit 23 of a testing device 24. Together with the adjusting device 19, the testing device 24 forms the leveling device 18 of the mechanical device 1.

In addition to the evaluation unit 23, the test device 24 comprises distance measuring devices, in the case shown by way of example distance measuring sensors 25, which are connected to the evaluation unit 23.

Before the vibration generator 12 is switched on, the distance measuring sensors 25 measure the vertical distance of the holding device 7 from a horizontally oriented mounting plane 26 of the support structure 16 at at least two, preferably at three, spaced-apart locations.

The measured values obtained by way of the distance measuring sensors 25 are evaluated in the evaluation unit 23 of the testing device 24. If the evaluation of the measured values shows that the holding device 7 is not parallel to the mounting plane 26 of the support structure 16 and is therefore not aligned horizontally, the evaluation unit 23 of the testing device 24, by driving the actuator 20 of the adjusting device 19, causes the vertical dimensions of the pneumatic bellows 17 to be adjusted by appropriately applying pressure to the pneumatic bellows 17 in such a way that the existing deviation of the alignment of the holding device 7 from the horizontal alignment is eliminated. The holding device 7 also horizontally aligns the combined product 5, 6 immobilized on the holding device 7.

Due to the horizontal alignment of the combined product 5, 6, the sheet metal parts 2 to be detached from the combined product 5, 6 are also horizontal and thus aligned in the same way as the deposition surface 14 of the pallet truck 15.

Instead of the pneumatic bellows 17, spring elements can be provided as spacers between the holding device 7 and the support structure 16, the vertical dimension of which spacers can be varied by adjusting the spring hardness.

After switching on the vibration generator 12, the sheet metal parts 2 detached from the combined product 5, 6 substantially retain their alignment parallel to the deposition surface 14 until they are deposited on the pallet truck 15. When they hit the deposition surface 14, the sheet metal parts 2 are at most slightly inclined toward the deposition surface 14. As a result, the sheet metal parts 2 are deposited in an orderly and gentle manner on the deposition surface 14 of the pallet truck 15.

FIG. 1 shows the mechanical arrangement 1 with a horizontal target alignment of the holding device 7 and the combined product 5 immobilized thereto.

FIG. 2 shows the conditions immediately after an adjustment of the positions of the grippers 9 of the holding device 7 due to the dimensions of the combined product 6. Due to the off-center arrangement of the combined product 6, the pneumatic bellows 17 of the adjusting device 19 are subjected to uneven loading by the holding device 7 and the combined product 6 immobilized thereon. As a result, the holding device 7 and the combined product 6 are in an inclined position.

In FIG. 3, the inclined position of the holding device 7 and the combined product 6 existing in FIG. 2 was corrected by the leveling device 18 in the manner described above.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A mechanical device for separating a workpiece part provided as a processing product from cutting processing of a plate-type workpiece, comprising a metal sheet, from a scrap skeleton provided as a further processing product from cutting processing of a workpiece under the effect of gravity from a combined product including the scrap skeleton and the workpiece part, the mechanical device comprising: a holder;
a separator; and
a product deposition area, wherein the holder is configured to immobilize, effective in a direction of gravity, the combined product before separation of the workpiece part and to immobilize, effective in the direction of gravity, the scrap skeleton after separation of the workpiece part, wherein the separator is configured to detach the workpiece part from the combined product immobilized by the holder, wherein the product deposition area is arranged at a vertical distance below the combined product immobilized by the holder, wherein the product deposition area for supporting the workpiece part detached from the combined product under the effect of gravity has a horizontal deposition surface which extends along the combined product immobilized by the holder, and
wherein a leveler is provided, by which, before the workpiece part is detached from the combined product immobilized by the holder, the combined product immobilized by the holder is configured to be aligned with a main plane of the combined product parallel to the horizontal deposition surface.

2. The mechanical device according to claim 1, wherein the leveler has a tester and an adjuster,
wherein an alignment of the main plane of the combined product immobilized by the holder relative to a horizontal reference plane is configured to be determined by the tester and
wherein, based on a deviation of a determined alignment of the main plane of the combined product immobilized by the holder from an alignment of the horizontal reference plane, the alignment of the combined product immobilized by the holder is configured to be adjusted by the adjuster such that the combined product immobilized by the holder extends with the main plane parallel to the horizontal reference plane.

3. The mechanical device according to claim 2,
wherein the alignment of the main plane of the combined product immobilized by the holder relative to the horizontal reference plane is determined by an alignment of the holder relative to the horizontal reference plane,
wherein the alignment of the holder relative to the horizontal reference plane is configured to be determined by the tester, and
wherein, based on a deviation of the determined alignment of the holder from the alignment of the horizontal reference plane, the alignment of the holder is configured to be adjusted by the adjuster such that the holder extends parallel to the horizontal reference plane.

4. The mechanical device according to claim 3,
wherein a support structure is provided for the holder,
wherein an actuator has at least one spacer provided in a vertical direction between the support structure and the holder and an actuator for the at least one spacer,
wherein the holder is effectively mounted on the support structure in the vertical direction by the at least one spacer and wherein a vertical dimension of the spacer is adjustable by the actuator, and
wherein, based on the deviation of the determined alignment of the holder from the alignment of the horizontal reference plane, the vertical dimension of the at least one spacer between the support structure and the holder is configured to be adjusted by the actuator such that the holder extends parallel to the horizontal reference plane.

5. The mechanical device according to claim 4,
wherein the adjuster has a plurality of spacers with adjustable vertical dimensions provided in the vertical direction between the support structure and the holder and offset from one another parallel to the main plane of the combined product immobilized by the holder, and
wherein, based on the deviation of the determined alignment of the holder from the alignment of the horizontal reference plane, the vertical dimensions of the spacers between the support structure and the holder is configured to be adjusted in a coordinated manner by the actuator such that the holder extends parallel to the horizontal reference plane.

6. The mechanical device according to claim 4,
wherein the support structure for the holder is horizontally aligned with a mounting plane of the support structure, in which the holder is effectively mounted on the support structure by the at least one spacer in the vertical direction,
wherein the alignment of the holder relative to the mounting plane of the support structure is configured to be determined by the tester of the leveler, and
wherein, based on a deviation of the determined alignment of the holder from the alignment of the mounting plane of the support structure, the alignment of the holder is configured to be adjusted by the adjuster such that the holder extends parallel to the mounting plane of the support structure.

7. The mechanical device according to claim 4,
wherein at least one of the at least one spacers is configured as a pneumatic bellows and
wherein, in order to adjust the vertical dimension of the pneumatic bellows, an internal pressure of the pneumatic bellows is configured to be adjusted by the actuator.

8. The mechanical device according to claim 4,
wherein at least one of the at least one spacers is configured as a spring element, and
wherein, in order to adjust the vertical dimension of the spring element, a spring hardness of the spring element is configured to be adjusted by the actuator.

9. The mechanical device according to claim 4,
wherein the separator has a vibration generator configured to generate vertical vibrations of the holder immobilizing the combined product, which vibrations cause the workpiece part to be detached from the combined product,
wherein for vibration isolation of the holder, a vertically elastic spring-damper is provided between the holder and the support structure, by which the holder is mounted on the support structure in such a manner as to be configured to vibrate vertically, and
wherein the spring-damper forms a spacer of the at least one spacers provided between the holder and the support structure and the vertical dimension of the spring-damper is adjustable by the actuator of the adjuster.

10. The mechanical device according to claim 9, wherein at least one pneumatic bellows is provided as the spring-damper between the holder and the support structure.

11. The mechanical device according to claim 9, wherein at least one spring element is provided as the spring-damper between the holder and the support structure.

12. The mechanical device according to claim 1,
wherein the holder has holding members and a base structure to which the holding members are attached and on which the holding members lie opposite one another with a mutual horizontal distance parallel to the main plane of the combined product immobilized by the holder,
wherein the combined product is configured to be effectively immobilized on the holder on the holding members in the direction of gravity, and
wherein at least one of the holding members is configured to be advanced parallel to the main plane of the combined product immobilized by the holder relative to the base structure.
